(19) United States
(12) Patent Application Publication
(10) Pub. No.: US 2007/0235067 A1
(43) Pub. Date: Oct. 11, 2007

(54) ROLLING WALKER

(75) Inventors: Bradley D. Gale, Rochester, NY (US); Joshua A. Trimble, Franklin, IN (US); David Chien, Taipei City (TW); Sean Ho, Taipei County (TW)

Correspondence Address: BARNES & THORNBURG LLP, 11 SOUTH MERIDIAN, INDIANAPOLIS, IN, 46204, US

(73) Assignee: Cosco Management, Inc., Wilmington, DE (US)

(21) Appl. No.: 11/278,115

(22) Filed: Mar. 30, 2006

(51) Int. Cl. A61H 3/00

(52) U.S. Cl. 135/67; 280/87.021

(57) ABSTRACT

A rolling walker includes a collapsible frame, a pair of upwardly extending push arms coupled to an upper portion of the frame, and at least one pair of wheel units coupled to a lower portion of the frame. The collapsible frame is configured for movement between an unfolded use position and a folded storage position.

### BACKGROUND

The present disclosure relates to ambulatory aids, and in particular to walkers. More particularly, the present disclosure relates to collapsible and height-adjustable rolling walkers.

### SUMMARY

A rolling walker in accordance with the present disclosure includes a collapsible frame having four legs, a pair of upwardly extending push arms mounted to top of the frame, and a wheel unit coupled to the bottom of each leg. The collapsible frame is configured for movement between an unfolded use position and a folded storage position.

In illustrative embodiments, the rolling walker includes laterally spaced first and second collapsible side frame units, each side frame unit having a front leg, a rear leg, an upper “bridge” link positioned to lie between upper portions of the front and rear legs, and a lower link extending between the front and rear legs and positioned to lie below the bridge link, a lock including a jaw assembly coupled to an upper end of the rear leg, a lock pin having a spring mounted for movement on the upper link, and a lock-release apparatus coupled to the walker frame.

In illustrative embodiments, the lock-release apparatus includes an actuator and a pair of cables coupled to the jaw assembly on a first end and to the actuator on a second end. Each cable is arranged to move a portion of the jaw against a biasing force provided by the spring to move the lock pin from a mated position extending into the jaw mechanism to establish a locked position of the rear leg to the bridge link and an unmated position disengaging the lock pin to allow pivoting movement of the rear leg relative to the bridge link. The locked position and unmated position of the lock pin correspond to an unfolded use position and a folded storage position, respectively, of the first and second collapsible side frame units.

Additional features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a rolling walker in accordance with the present disclosure, with portions broken away, showing laterally spaced first and second collapsible side frame units, two upwardly extending push arms, each push arm being coupled to an tipper portion of companion first and second collapsible side frame units, four wheel units, two wheel units being coupled to a lower portion of the first side frame unit and two other wheel units being coupled to a lower portion of the second collapsible side frame unit, a portion of a seat-and-basket unit positioned to lie between the first and second collapsible side frame units, and a lower crossbar coupled to the first and second collapsible side frame units and located below the seat-and-basket unit, each of the first and second collapsible side frame units comprising a “four-bar” linkage as suggested illustratively in FIG. 6 and diagrammatically in FIGS. 7-9;

FIG. 2 is another perspective view of the rolling walker of FIG. 1;

FIGS. 3-5 show movement of components included in the rolling walker as the rolling walker is moved (e.g., collapsed) from an unfolded use position to a folded storage position;

FIG. 3 is a side elevation view showing the rolling walker in the unfolded use position, and further showing a first leg included in the first side frame unit and coupled to the first upwardly extending push arm and a first wheel unit, a second leg extending away from a mid-point of the first leg and coupled to a second wheel unit;

FIG. 4 is a side elevation view showing a partly collapsed rolling walker during movement from the unfolded use position toward the folded storage position;

FIG. 5 is a side elevation view of the rolling walker after it has been moved to assume the folded storage position;

FIG. 6 is an enlarged exploded perspective view of illustrative components included in the first side frame unit of FIGS. 1-5 showing (counter-clockwise from left) the first leg unit providing a first bar, a lower link providing a second bar, the second leg unit providing a third bar, and a bridge link providing a fourth bar, and showing a pivot pin is associated with a pivot joint established between each pair of adjacent bars and that the four bars and four pivot pins cooperate to define the four-bar linkage;

FIG. 7 is a “free-body” diagram of the structure of FIG. 3 showing diagrammatically the four-bar linkage of the first side frame unit in the unfolded use position shown in FIG. 3;

FIG. 8 is a free-body diagram of the structure of FIG. 4 showing diagrammatically the four-bar linkage of the first side frame unit in the partly collapsed position shown in FIG. 4;

FIG. 9 is a free-body diagram of the structure of FIG. 5 showing diagrammatically the four-bar linkage of the first side frame unit in the folded storage position shown in FIG. 5;

FIG. 10 is an enlarged side elevation view, with portions broken away, showing a portion of a lock associated with the bridge link where a lock pin is received in a pin keeper passage to block pivoting movement of the bridge link;

FIG. 11 is an enlarged side elevation view, with portions broken away, showing a portion of the first side frame unit in the unfolded use position shown in FIG. 3;

FIG. 12 is a view similar to FIG. 11 showing a cable being moved in response to the manual operation of a one-hand actuator by the user to cause a lock pin associated with the bridge link to move out of a pin receiver to allow the bridge link to pivot counterclockwise about the first leg while the second leg pivots clockwise about the bridge link away from the first leg so that the user can collapse the rolling walker to the folded storage position;

FIG. 13 is a view similar to FIGS. 11 and 12 showing a portion of the four-bar linkage in the folded storage position shown in FIG. 5;

FIG. 14 is a sectional view taken along lines 14-14 of FIG. 3, with portions broken away, of the four-bar linkage in the unfolded use position showing the lock associated with the bridge link including a lock pin mover configured to move the lock pin out of the pin receiver;

FIG. 15 is a perspective view of the pin mover of FIG. 14, with portions broken away, showing the pin mover coupled to a first cable end;

FIG. 16 is a view similar to FIG. 6 showing another embodiment of a side frame unit in accordance with the present disclosure; and

FIG. 17 is an exploded perspective view of the rolling walker of FIG. 1 showing the rolling walker configured for shipping in a shipping carton where the four-bar linkages included in the first and second collapsible side frame units have been moved to the folded storage position.

### DETAILED DESCRIPTION

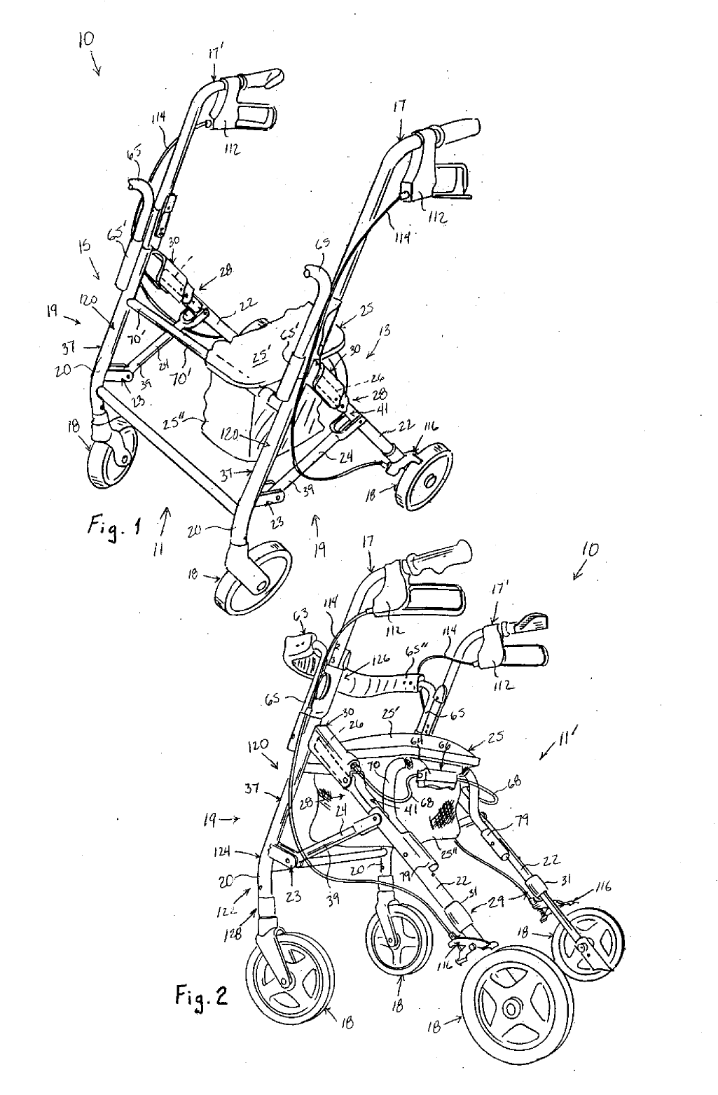

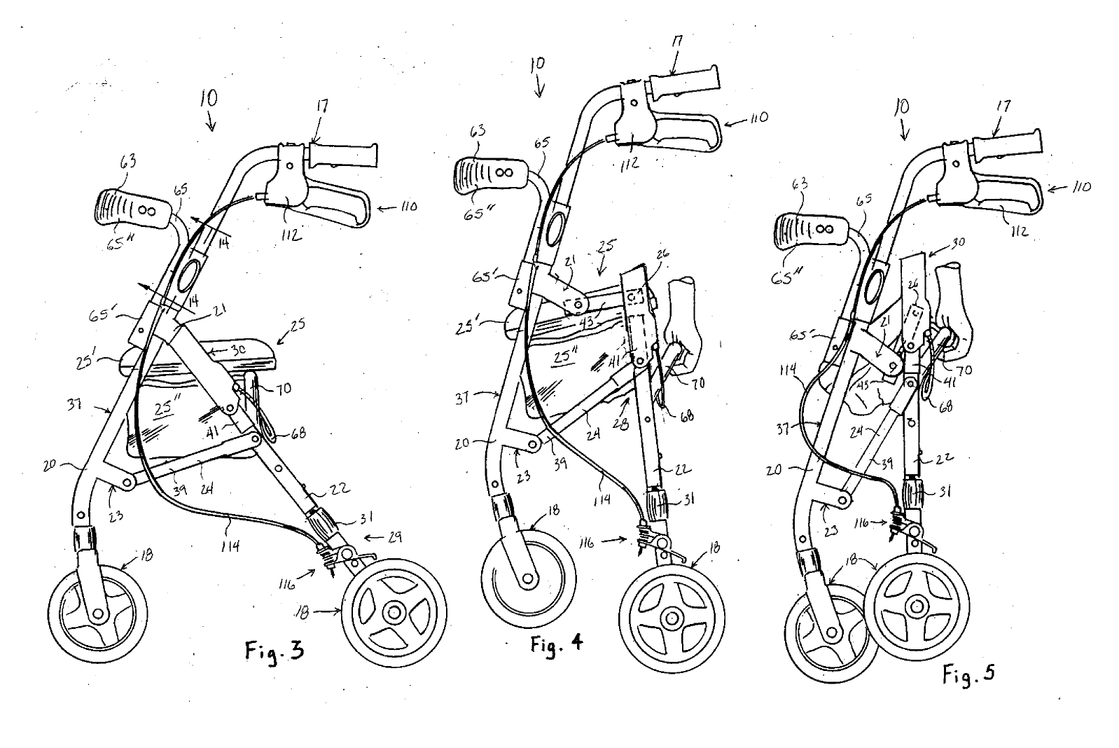

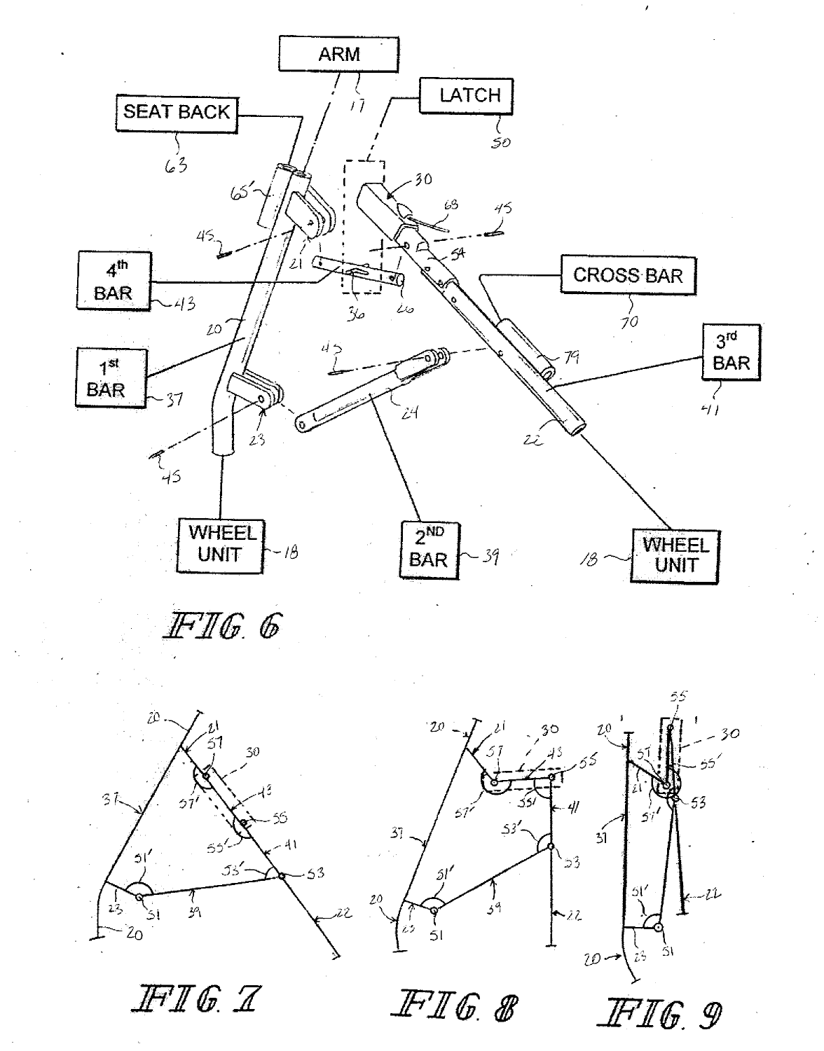

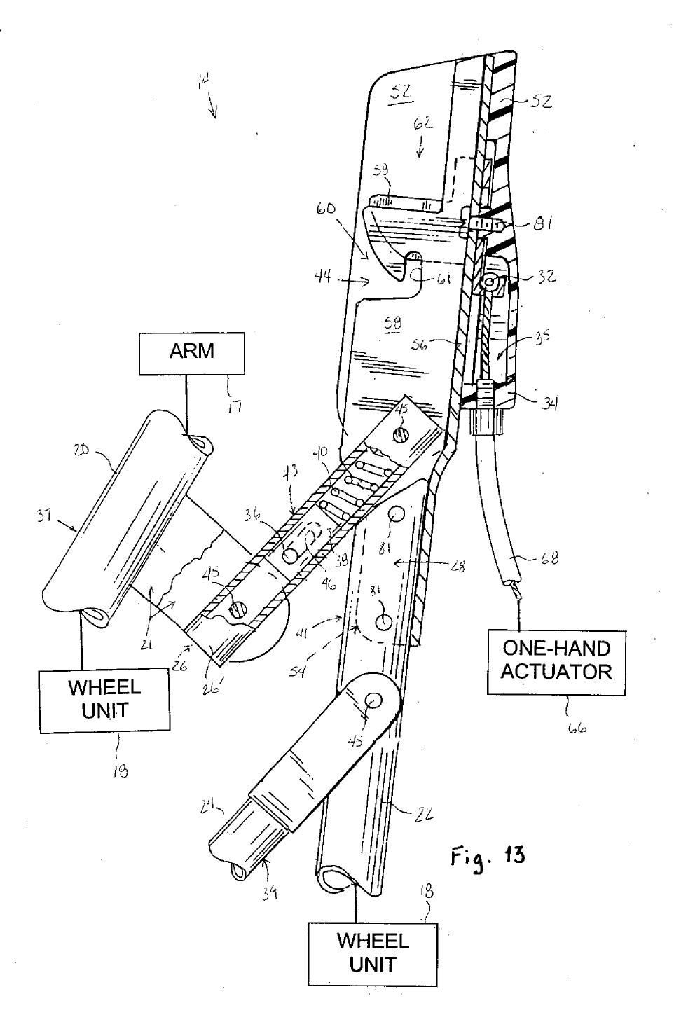

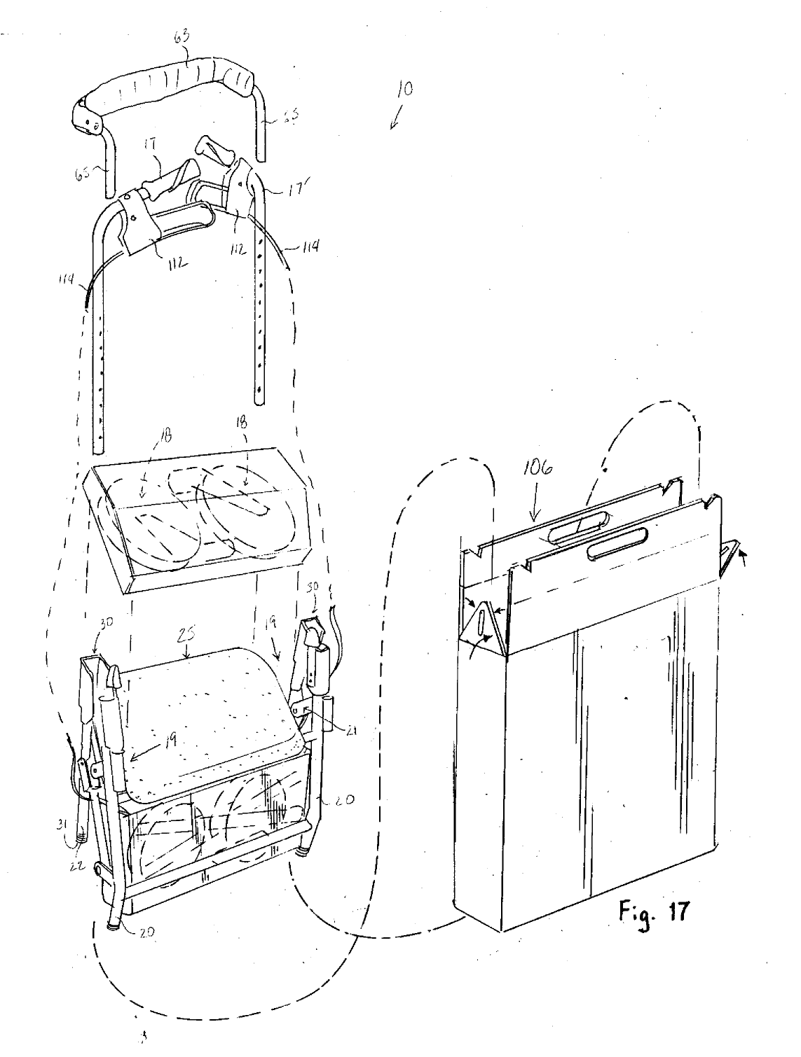

A rolling walker 10 for use by persons in need of ambulatory assistance is provided. Rolling walker 10 includes laterally spaced first and second collapsible side frame units 13, 15 having a foldable “four-bar” linkage 19 configured to allow a user to collapse first and second collapsible side frame units 13, 15 between an unfolded use position, as shown in FIGS. 1 and 2, and a folded storage position as shown in FIG. 5 in the manner shown in FIGS. 3-5. The various components of the foldable four-bar linkage are shown in FIG. 6. The collapsing action of four-bar linkage 19 is shown in “free-body” diagrams in FIGS. 7-9. A lock 14 is provided to lock four-bar linkage 19 in the unfolded use position as shown in FIG. 11 and to unlock and enable movement of foldable four-bar linkage 19 as shown in FIGS. 12 and 13 corresponding to the folded storage position. Rolling walker 10 can be shipped in an unassembled state in a relatively small and compact carton as suggested in FIG. 17

Rolling walker 10 further includes a first and a second upwardly extending push arm 17, 17′, each push arm 17, 17′ being coupled to an upper portion of companion first and second collapsible side frame units 13, 15, four wheel units 18, two wheel units 18 being coupled to a lower portion of first side frame unit 13 and two other wheel units 18 being coupled to a lower portion of second collapsible side frame unit 15, foldable four-bar linkage 19, a seat-and-basket unit 25 positioned to lie between first and second collapsible side frame units 13, 15, and a lower crossbar 70 located below seat-and-basket unit 25 and positioned to extend between first and second collapsible side frame units 13, 15.

Referring now to FIGS. 3-5, first and second collapsible side frame units 13, 15 are similar to one another in structure and function so that the description of one collapsible side frame unit 13, 15 applies to the other collapsible side frame unit 13, 15 as well. First collapsible side frame unit 13 includes a first leg unit 20 having a second pivot mount 21 comprising an upper mounting bracket 21 coupled to an upper portion of first leg unit 21 to lie in close proximity to push arm 17 and having a distal end arranged to lie in spaced-apart relation to first leg unit 20, and a first pivot mount 23 comprising a lower mounting bracket 23 coupled to a lower portion of first leg unit 20 to lie in close proximity to wheel unit 18 and formed to include a distal end arranged to lie in spaced-apart relation to first leg unit 20, a second leg unit 22, a lower link 24 pivotably coupled to and extending between lower mounting bracket 23 of first leg unit 20 and second leg unit 22, and an upper “bridge” link 26. Illustratively, first leg unit 20 is a front leg 20 and second leg unit 22 is a rear leg 22. Bridge link 26 is pivotably coupled to an upper end 28 of rear leg 22 on one end and pivotably coupled to upper mounting bracket 21 on another end to connect front leg 20 and a first end portion 28 of rear leg 22. Illustratively, first end portion 28 is an upper end 28.

Each front leg 20 is coupled to one upwardly extending push arm 17 or 17′ on an upper end and coupled to one wheel unit 18 on a lower end as shown, for example, in FIGS. 1 and 2. A portion of front leg 20 provides a first bar 37 of foldable four-bar linkage 19. Front leg 20 includes a longer portion 120 and a shorter portion 122 shorter than the longer portion, a bend 124 is positioned between longer portion 120 and shorter portion 122 so that longer and shorter portions 120, 122 are angled relative to one another, longer portion 120 includes a first end portion 126 formed to include a push arm receiver channel 130 to which push arm 17 or 17′ is coupled, and shorter portion 122 includes a second end portion 128 to which one wheel unit 18 is coupled.

Rear leg 22 includes a first end portion 28 or upper end 28 and a second end portion 29. Rear leg 22 is coupled to a jaw assembly 30 on upper end 28 of rear leg 22, as shown best in FIG. 6. Jaw assembly 30 extends away from rear leg 22 and is positioned to lie in an in-line relation thereto. Illustratively, second end portion 29 is a lower end 29 and is formed to include a wheel unit receiver 31 to receive and couple one wheel unit 18 to rear leg 22. A portion of rear leg 22 provides a third bar 41 of foldable four-bar linkage 19.

Lower link 24 is pivotably coupled to lower mounting bracket 23 on one end and pivotably coupled to rear leg 22 on another end as shown, for example, in FIG. 6. Lower link 24 provides a second bar 39 of foldable four-bar linkage 19.

Bridge link 26 is formed to include a pair of apertures in each end portion to receive a pivot pin 45 for pivotably coupling bridge link 26 to upper mounting bracket 21 and rear leg 22 as shown in FIGS. 11-13. Bridge link 26 is further formed to include a parallel pair of oblong pin-guide apertures 46 or slots 46 extending along a center portion of link 26. Bridge link 26 is tubular in cross-section so as to be formed to include an interior channel 48 and an exterior wall 26′ through which, in series, a pin carrier 38 comprising a lock pin block 38 and a spring 40 extend. A lock pin 36 is coupled to lock pin block 38 and arranged to extend through oblong pin-guide apertures 46. Bridge link 26 thus provides means for lock pin 36 and lock pin block 38 to move slidably in response to a bias force applied by spring 40. Bridge link 26 provides a fourth bar 43 of foldable four-bar linkage 19. Illustratively, bridge link 26 has a short length and lower link 24 has a long length that is longer than the short length.

Seat-and-basket unit 25 includes a seat 25′ and a basket 25″ and is positioned to lie between the first and second collapsible side frame units 13, 15, as shown once again in FIGS. 1-5. Seat 25′ is generally rectangular in shape and is pivotably coupled on one edge to a crossbar 70′ extending between front legs 20 and an opposite edge is positioned to rest on an upper portion of crossbar 70. Basket 25″ is coupled to crossbars 70 and 70′ and is positioned to extend below and therebetween. Thus, seat 25′ substantially covers an open portion of basket 25″ when seat 25′ is in a closed position. The user is able to pivot seat 25′ about crossbar 70′ to an opened position to gain access to an interior portion of basket 25″ to store or retrieve personal items therein. Crossbar 70 is generally U-shaped and is tubular in cross-section. A crossbar receiver 79 is coupled to each rear leg 22 to receive an end portion of crossbar 70 to couple crossbar 70 between first and second collapsible side frame units 13, 15.

A seat back 63 is provided as shown best in FIG. 2. Seat back 63 includes a pair of mounting posts 65, a pair of seat back mount receivers 65′ coupled to the upper portion of each front leg 20 and arranged to lie in a spaced-apart relation to upper mounting bracket 21, and a belt portion 65″ coupled to and extending between mounting posts 65. Seat back 63 is configured to provide the user with a back rest when the user is seated in seat 25′.

A braking system 110 is provided to assist the user in controlling the movement of rolling walker 10 as shown, for example, in FIGS. 1-5. Braking system 110 includes a pair of hand brakes 112, a pair of brake cables 114, and a pair of brakes 116 coupled to rear legs 22 to arrest the rotation of wheel units 18.

Referring now to the free body diagrams of FIGS. 7-9, first bar 37 is coupled to second bar 39 to establish a first pivot joint 51 and define a first included angle 51′ therebetween. Second bar 39 is coupled to third bar 41 to establish a second pivot joint 53 and define a second included angle 53′ therebetween. Third bar 41 is coupled to fourth bar 43 to establish a third pivot joint 55 and define a third included angle 55′ therebetween. Fourth bar 43 is coupled to first bar 37 to establish a fourth pivot joint 57 and define a fourth included angle 57′ therebetween.

First link 37, second link 39, third link 41, fourth link 43, and first lock unit 14 cooperate to define a leg-movement control system as shown in FIGS. 5 and 9. The leg-movement control systems is configured to selectively retain first bridge link 26 (associated with the first side frame unit 13) in fixed relation to first rear leg 22 to establish the unfolded use position of first side frame unit 13 comprising first front leg 20, first and second pivot mounts 21, 23 coupled to first front leg 20, first rear leg 22, first lower link 24, and first bridge link 24, and to release first bridge link 26 to pivot relative to rear leg 22 to establish the folded storage position of first side frame unit 13.

Upon movement by the user of collapsible side frame unit 13 toward the unfolded use position of FIGS. 3 and 7, first included angle 51′ of about 135°, second included angle 53′ of about 70°, third included angle 55′ of about 180°, and fourth included angle 57′ of about 180° are defined. Upon subsequent movement by the user of collapsible side frame unit 13 toward the folded storage position of FIGS. 5 and 9, first included angle 51′ of about 105°, second included angle 53′ of about 145°, third included angle 55′ of about 35°, and fourth included angle 57′ of about 270° are defined. Thus, first collapsible side frame unit 13 has a folded shape different from an unfolded shape.

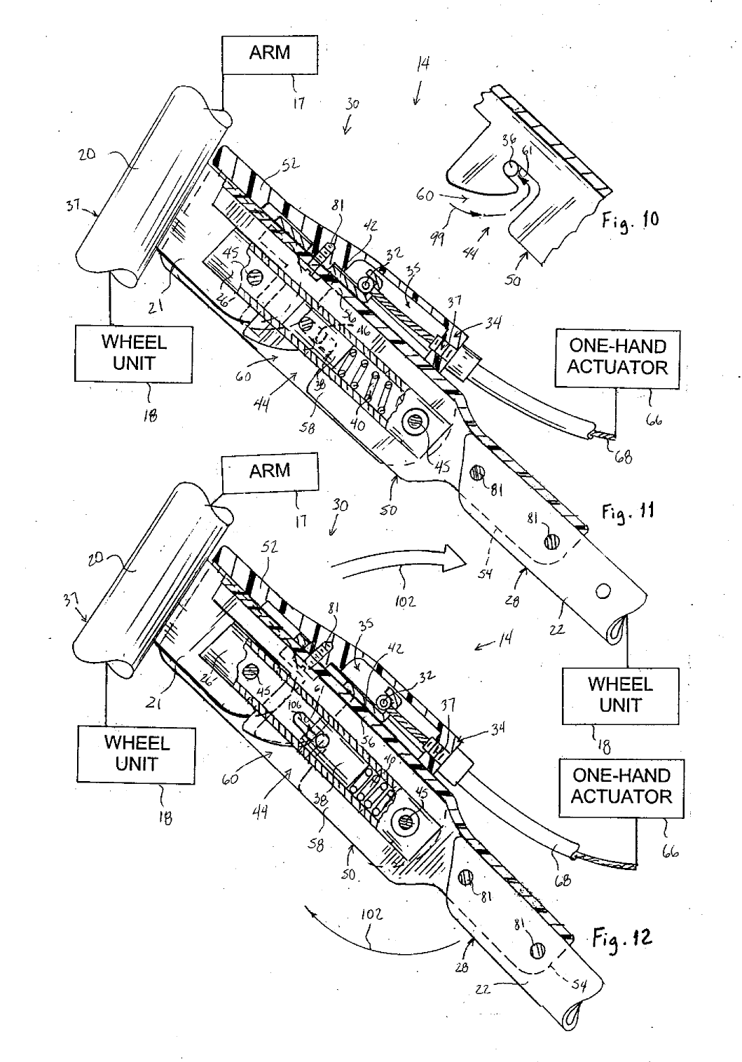

Referring now to FIG. 10, illustratively, lock 14 is a bridge link lock 14 and is configured to block movement of bridge link 26 relative to front and rear legs 20, 22 to maintain bridge link 26 in an in-line locked position. Bridge link lock 14 further allows the user to enable movement of bridge link 26 relative to front and rear legs 20, 22 so that bridge link 26 and rear leg 22 can be moved to an angled unlocked position (as shown in FIG. 13). Bridge link lock 14 includes jaw assembly 30 coupled to top end 28 of rear leg 22, a first cable end portion 32, a cable connector assembly 34, lock pin 36, lock pin block 38, spring 40, a pin mover 42, a pair of R-shaped pin receiver channels 44, and a protective guard 52.

Jaw assembly 30 includes a jaw 50 coupled to and extending away from top end 28 of rear leg 22, as shown best in FIG. 13. Jaw 50 includes a sleeve portion 54 coupled to and substantially surrounding a portion of top end 28, a planar portion 56 coupled to and extending away from sleeve portion 54 in an in-line relation to rear leg 22, and a pair of spaced-apart flanges 58 depending from planar portion 56. Each flange 58 is coupled along a top edge of each flange 58 to an edge of planar portion 56 and further coupled on another edge to sleeve portion 54. Planar portion 56 cooperates with flanges 58 to form a U-shaped cavity 62 therebetween. U-shaped cavity 62 is configured to receive bridge link 26 when bridge link lock 14 is in the locked position.

Flanges 58 are formed to include R-shaped pin receiver channels 44. Each pin receiver channel 44 is formed to include an entry passage 60 comprising a pin-capture notch 60 and a pin keeper passage 61, as shown in FIG. 13. Pin capture notch 60 is configured to capture and guide lock pin 36 in a direction 99 into pin receiver channel 44 and pin keeper passage 61 as bridge link lock 14 and jaw assembly 30 are moved from the unlocked position toward the locked position. Flanges 58 are further formed to include a pair of apertures 49 adjacent to sleeve portion 54. Referring now to FIG. 6, apertures 49 align with companion apertures formed in bridge link 26 to receive pivot pin 45 therethrough to establish a pivot axis 47. Bridge link 26 pivots about pivot axis 47 in relation to rear leg 22.

Protective guard 52 extends about U-shaped jaw 50, as shown best in FIGS. 11 and 12. Illustratively, protective guard 52 is U-shaped and substantially covers planar portion 56 and flanges 58 to protect the user from unintended contact with bridge link lock 14. Illustratively, protective guard 52 is configured as a generally U-shaped jacket constructed of a plastic material. However, protective guard 52 may be constructed of any suitable material such as steel, aluminum, wood, or any other suitable material. Protective guard 52 is formed to include cable connector assembly 34 having an aperture 37 configured to receive first cable end portion 32 therethrough to couple first cable end portion 32 to pin mover 42. Cable connector assembly 34 defines an interior cavity 3 5 arranged to receive a portion of pin mover 42 for slidable movement therein.

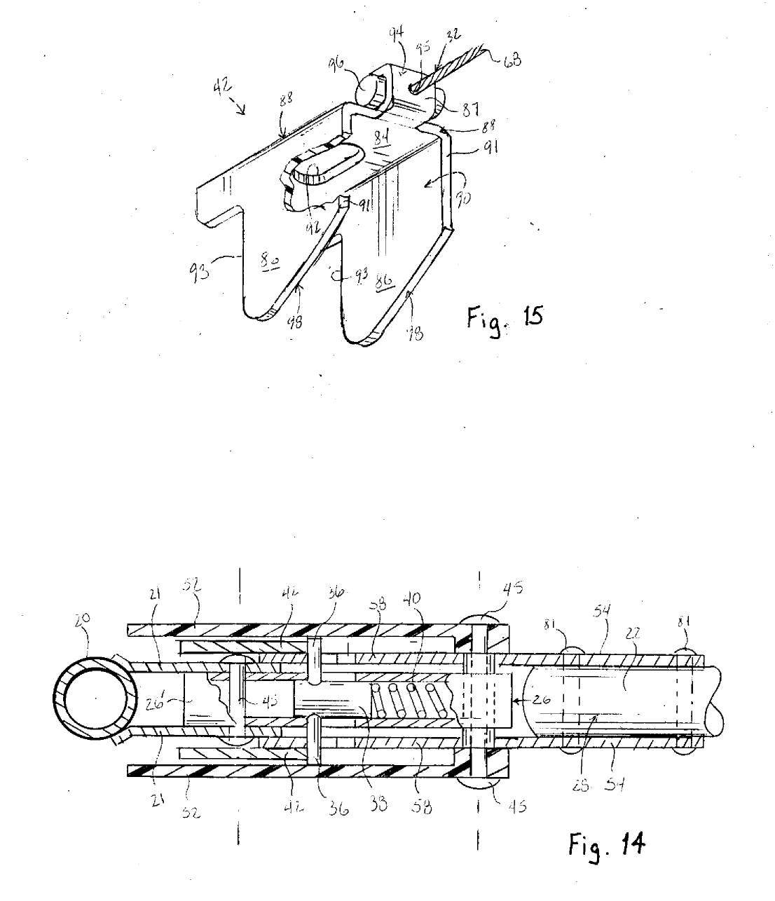

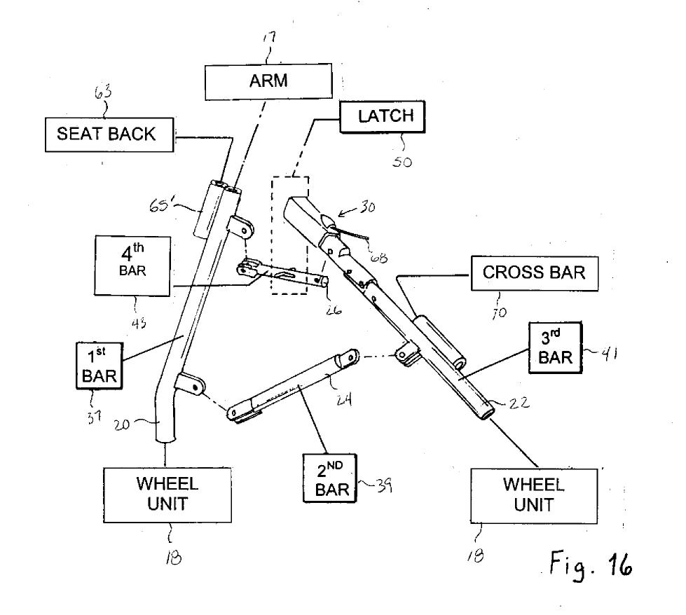

Referring now to FIGS. 14 and 15, U-shaped pin mover 42 is slidably coupled to a first surface 82 of planar portion 56. Pin mover 42 includes a horizontal wall 84, a pair of vertical walls 86 depending from edges 88 to form a U-shaped channel 90 therebetween, and a cable anchor receiver 94. Horizontal wall 84 is formed to include an oblong guide slot 92 configured to receive a fastener 81 therethrough to couple pin mover 42 to jaw 50. Cable anchor receiver 94 includes a generally U-shaped flange 87 having an aperture 95 configured to receive a portion of cable 68 therethrough and coupled to an edge adjacent to oblong guide slot of horizontal wall 84. U-shaped flange 87 extends upwardly from horizontal wall 84 and is arranged to receive an anchor 96 coupled to first cable end portion 32 to interconnect each cable 68 with each pin mover 42. Each vertical wall 86 includes a first edge 91, a second edge 93, and a pin-pusher edge 98 positioned to lie between first edge 91 and second edge 93. Pin-pusher edge 98 is generally oblique in relation to edges 91 and 93 and has a generally arcuate profile. Pin pusher edge 98 is arranged to confront lock pin 36 to push lock pin 36 out of pin keeper passage 61 to unlock bridge link lock 14 to enable pivoting movement of bridge link 26 in relation to front and rear legs 20, 22 so that bridge link 26 can be moved to the angled unlocked position.

Lock-release apparatus 16 includes a housing 64, a one-hand actuator 66, and left and right cables 68, as shown in FIGS. 11-13. Housing 64 is coupled to a crossbar 70 extending between rear legs 22. Actuator 66 is coupled to housing 64 for slidable movement therein.

Referring once again to FIGS. 3-5 and 11-13, to unlock cable 68 is pulled toward lock-release 16 in response to the manual operation of one-hand actuator 66 by the user. Cable movement away from lock 14 causes lock pin 36 to move out of pin-keeper passage 61 in a direction 106 enabling bridge link 26 to pivot counterclockwise in a direction 100 about front leg 20. Simultaneously, rear leg 22 pivots clockwise in a direction 102 about bridge link 26 away from front leg 20 and lower link 24 pivots counterclockwise with respect to front leg 20 in a direction 104 so that the user can collapse collapsible frame 12 to a folded storage position.

When collapsible side frame unit 13 is in the folded storage position, bridge link 26 and rear leg 22 are positioned to lie in an angled relation to one another as shown best in FIGS. 5 and 13. In the unfolded use position shown in FIGS. 3 and 11, bridge link 26 and rear leg 22 are positioned to lie in the in-line relation to one another.

First and second front legs 20, front crossbar 70′positioned to interconnect first and second front legs 20, first and second pivot mounts 21, 23 coupled to first and second front legs 20, wheel units 18 coupled to first and second front legs 20 comprising front wheel units 18, and push arms 17, 17′ cooperate to define a front assembly 11 as shown in FIG. 1. First and second rear legs 22, cross bar 70 interconnecting first and second rear legs 22, and wheel units 18 coupled to first and second rear legs 22 comprising rear wheel units 18 cooperate to define a rear assembly 11′ as shown best in FIG. 2.

Foldable four-bar linkage 19 may be useful for configuring rolling walker 10 for shipment to, for example, a retailer as shown in FIG. 17. A manufacturer is able to remove upwardly extending push arms 17, 17′ and wheel units 18, and move first and second collapsible side frame units 13, 15 toward the folded storage position so that rolling walker 10 can assume a smaller profile suitable for insertion into a shipping carton 106.

With respect first and second collapsible side frame units 13, 15, first bar 37, second bar, 39, third bar 41, and fourth bar 43 cooperate to provide means for maintaining first and second collapsible side frame units 13, 15 in the unfolded use position. First bar 37, second bar, 39, third bar 41, and fourth bar 43 also cooperate to provide collapsing means for collapsing first and second collapsible side frame units 13, 15 toward the folded storage position.

1. A rolling walker comprising
first and second collapsible side frame units laterally spaced from one another, each side frame unit including a first leg unit coupled to a second leg unit,
a pair of upwardly extending push arms, each push arm being coupled to an upper portion of each of the first and second collapsible side frame units,
at least one wheel unit coupled to a lower portion of each side frame unit, and
collapsing means for collapsing the first and second collapsible side frame units between an unfolded use position and a folded storage position.

2. The rolling walker of claim 1, wherein the collapsing means includes a first bar, a second bar, a third bar, and a fourth bar, a portion of the first leg unit providing the first bar, a lower link providing the second bar, a portion of the second leg unit providing the third bar, and a bridge link providing the fourth bar, the first bar being coupled to the second bar to establish a first pivot joint therebetween, the second bar being coupled to the third bar to establish a second pivot joint therebetween, the third bar being coupled to the fourth bar to establish a third pivot joint therebetween, the fourth bar being coupled to the first bar to establish a fourth pivot joint therebetween, and a pivot pin being associated with each pivot joint established between each pair of adjacent bars, wherein the four bars and four pivot pins cooperate to define a four-bar linkage.

3. The rolling walker of claim 2, wherein upon movement of the side frame unit to the unfolded use position, a first included angle of about 135° is defined by the first bar and the second bar, a second included angle of about 70° is defined by the second bar and the third bar, a third included angle of about 180° is defined by the third bar and the fourth bar, and a fourth included angle of about 180° is defined by the fourth bar and the first bar, and upon movement to the folded storage position the first included angle is about 105°, the second included angle is about 145°, the third included angle is about 35°, and the fourth included angle is about 270°.

4. The rolling walker of claim 2, wherein the bridge link and the second leg are positioned to lie in an angled relation to one another when the side frame units are moved to the folded storage position and the bridge link and the second leg are positioned to lie in an in-line relation to one another when the side frame units are moved to the unfolded use position.

5. The rolling walker of claim 2, wherein the bridge link further includes lock means coupled to the bridge link for blocking movement of the bridge link relative to the first and second leg units upon movement of the side frame units to the unfolded use position.

6. The rolling walker of claim 2, further comprising a lock pin slidably coupled to the bridge link and a jaw assembly coupled to an end portion of the second leg unit, wherein the jaw assembly is arranged to engage the lock pin so that the jaw assembly and the lock pin cooperate to lock the bridge link in the in-line relation to the second leg when the first and second collapsible side frame units are in the unfolded use position.

7. The rolling walker of claim 6, wherein the jaw assembly is formed to include a pin keeper passage.

8. The rolling walker of claim 1, wherein the first leg unit includes a first end portion having an upper mounting bracket and formed to include a push arm receiver channel, a second end portion, a bend positioned to lie between the first end portion and the second end portion, and a lower mounting bracket coupled to the first leg unit between the bend and the upper mounting bracket.

9. The rolling walker of claim 8, further comprising a bridge link, wherein a first end portion of the bridge link is coupled to the upper mounting bracket for pivotable movement thereabout and a first end portion of the lower link is coupled to the lower mounting bracket for pivotable movement thereabout.

10. The rolling walker of claim 8, wherein the first leg unit includes a longer portion and a shorter portion shorter than the longer portion, the bend is positioned between the longer portion and the shorter portion so that the longer and shorter portions are angled relative to one another, the longer portion includes the first end portion to which the push arm is coupled, and the shorter portion includes the second end portion to which the wheel unit is coupled.

11. The rolling walker of claim 1, wherein the second leg unit includes a first end portion, a second end portion, and a jaw assembly coupled to and extending away from the first end portion.

12. The rolling walker of claim 11, wherein the second end portion is formed to include a wheel unit receiver.

13. The rolling walker of claim 11, further comprising a crossbar having a crossbar receiver, wherein the crossbar is positioned to extend between the first and second collapsible side frame units and the crossbar receiver is coupled to each second leg unit between the first end portion and the second end portion.

14. The rolling walker of claim 11, wherein the jaw assembly is pivotably coupled to the fourth bar and the second bar is pivotably coupled to the second leg unit between the first end unit and the second end unit.

15. The rolling walker of claim 14, wherein the jaw assembly is U-shaped and a portion of the jaw assembly is positioned to cover at least a portion of the first end portion.

16. The rolling walker of claim 14, wherein the jaw assembly is positioned to cover at least a portion of the fourth bar when the side frame unit is in the unfolded use position.

17. A rolling walker comprising
four wheel units,
first and second push arms, and
first and second collapsible side frame units, each of the first and second collapsible side frame units including a lower portion coupled to two of the four wheel units and an upper portion coupled to one of the first and second push arms, wherein the first collapsible side frame unit includes a foldable four-bar linkage configured to be moved to assume one of an unfolded use position having an unfolded shape to locate a first of the wheel units on the lower portion in spaced-apart relation to a second of the wheel units on the lower portion and a folded storage position having a folded shape different from the unfolded shape to locate the first of the wheel units on the lower portion in close proximity to the second of the wheel units on the lower portion and the first collapsible side frame unit further includes a lock unit coupled to the foldable four-bar linkage and configured to selectively retain the foldable four-bar linkage in the unfolded shape.

18. The rolling walker of claim 17, wherein the foldable four-bar linkage includes a first bar coupled to the first of the wheel units and to the first push arm, a third bar coupled to the second of the wheel units, a second bar pivotably coupled to each of the first and third bars, and a fourth bar pivotably coupled to each of the first and third bars.

19. The rolling walker of claim 18, wherein the fourth bar has a short length and the second bar has a long length that is longer than the short length.

20. The rolling walker of claim 19, wherein the lock unit is coupled to each of the third and fourth bars.

21. The rolling walker of claim 19, wherein the lock unit comprises a lock pin arranged to slide back and forth in a slot formed in the fourth bar, a spring coupled to the fourth bar and arranged to yieldably urge the lock pin to move to one end of the slot, a jaw formed to include an R-shaped pin receiver and coupled to the upper end of the third bar to receive the lock pin in a pin keeper portion of the R-shaped pin receiver upon movement of the foldable four-bar linkage to assume the unfolded shape to block pivotable movement of the third bar relative to the fourth bar to retain the foldable four-bar linkage in the unfolded shape, and the lock pin is arranged to be moved toward an opposite second end of the slot against a biasing force provided by the spring to exit the pin keeper portion of the R-shaped pin receiver formed in the jaw to free the third and fourth bars to pivot relative to one another to release the foldable four-bar linkage so that the foldable four-bar linkage can be moved to assume the folded shape.

22. The rolling walker of claim 19, wherein the first bar includes a front leg coupled to the first of the wheel units and to the first push arm, a first pivot mount coupled to a lower portion of the front leg to lie in close proximity to the first of the wheel units and formed to include a distal end arranged to lie in spaced-apart relation to the front leg and pivotably coupled to the second bar, and a second pivot mount coupled to an upper portion of the front leg to lie in close proximity to the first push arm and formed to include a distal end arranged to lie in spaced-apart relation to the front leg and pivotably coupled to the fourth bar.

23. The rolling walker of claim 18, wherein the first bar includes a front leg coupled to the first of the wheel units and to the first push arm, a first pivot mount coupled to a lower portion of the front leg to lie in close proximity to the first of the wheel units and formed to include a distal end arranged to lie in spaced-apart relation to the front leg and pivotably coupled to the second bar, and a second pivot mount coupled to an upper portion of the front leg to lie in close proximity to the first push arm and formed to include a distal end arranged to lie in spaced-apart relation to the front leg and pivotably coupled to the fourth bar.

24. The rolling walker of claim 23, wherein the first bar further includes a seat back mount receiver coupled to the upper portion of the front leg and arranged to lie in spaced-apart relation to the second pivot mount to locate the upper portion of the front leg therebetween and further comprising a seat coupled to the first and third bars and a seat back coupled to the seat back mount receiver.

25. The rolling walker of claim 23, wherein, when the four-bar linkage is moved to assume the unfolded use position, the first pivot mount and the first bar cooperate to define an included angle of about 135° therebetween, the second and third bars cooperate to define an included angle of about 70° therebetween, the third and fourth bars cooperate to define an included angle of about 180° therebetween, and the second pivot mount and the fourth bar cooperate to define an included angle of about 180° therebetween.

26. The rolling walker of claim 25, wherein the first pivot mount and the front leg cooperate to form an included angle of about 90° therebetween and the second pivot mount and the front leg cooperate to define an included angle of about 65° therebetween.

27. The rolling walker of claim 18, wherein the fourth bar is formed to include an interior channel and an exterior wall formed to include an elongated slot opening into the interior channel and the lock unit includes a pin carrier mounted for back-and-forth sliding movement in the interior channel, a lock pin coupled to the pin carrier to move therewith relative to the fourth bar and arranged to extend through the elongated slot, and a spring arranged to lie in the interior channel and configured to define means for yieldably moving the pin carrier in the interior channel to urge the lock pin to engage one end of the elongated slot.

28. The rolling walker of claim 27, wherein the first lock unit further includes a jaw formed to include an R-shaped pin receiver providing an entry passage and a pin keeper passage extending from the entry passage at about a right angle to the entry passage and, when the four-bar linkage is moved to assume the unfolded use position, the lock pin is arranged to lie in the pin keeper passage and retained in the pin keeper passage by a yieldable biasing force applied to the pin carrier by the spring.

29. The rolling walker of claim 28, wherein the jaw is also formed to include a cavity communicating with the R-shaped pin receiver and the fourth bar is arranged to lie in the cavity upon movement of the four-bar linkage to assume the unfolded use position and to lie substantially outside the cavity upon movement of the four-bar linkage to assume the folded storage position.

30. The rolling walker of claim 29, wherein the first bar includes a front leg coupled to the first of the wheel units and to the first push arm and a pivot mount coupled to an upper portion of the front leg to lie in close proximity to the first push arm and formed to include a distal end arranged to lie in spaced-apart relation to the front leg and pivotably coupled to the fourth bar and wherein the distal end of the pivot mount is arranged to lie in the cavity formed in the jaw upon movement o the four-bar linkage to assume the folded storage position.

31. The rolling walker of claim 28, wherein the lock unit further includes means for moving the pin carrier in the interior channel formed in the fourth bar against the yieldable biasing force applied by the spring to move the lock pin in the elongated slot toward an opposite end of the elongated slot and to move the lock pin out of the pin keeper passage and into the entry passage to free the fourth bar for pivotable movement relative to the third bar to allow the four-bar linkage to move to assume the folded storage position.

32. The rolling walker of claim 17, wherein the second and third bars cooperate to form therebetween an included angle of about 70° when the four-bar linkage has been moved to assume the unfolded use position and of about 145° when the four-bar linkage has been moved to assume the folded storage position.

33. The rolling walker of claim 17, wherein the third and fourth bars cooperate to form therebetween an included angle of about 180° when the four-bar linkage has been moved to assume the unfolded use position and of about 35° when the four-bar linkage has been moved to assume the folded storage position.

34. The rolling walker of claim 17, wherein the third bar includes a lower end coupled to the second of the wheel units and an upper end coupled to the lock unit and the fourth bar includes a first end pivotably coupled to the first bar and a second end pivotably coupled to a mid-portion of the fourth bar located on the fourth bar between the lock unit and the lower end of the third bar.

35. The rolling walker of claim 34, wherein the lock unit comprises a lock pin arranged to slide back and forth in a slot formed in the fourth bar, a spring coupled to the fourth bar and arranged to yieldably urge the lock pin to move to one end of the slot, a jaw formed to include an R-shaped pin receiver and coupled to the upper end of the third bar to receive the lock pin in the pin receiver upon movement of the foldable four-bar linkage to assume the unfolded shape to block pivotable movement of the third bar relative to the fourth bar to retain the foldable four-bar linkage in the unfolded shape, and the lock pin is arranged to be moved toward an opposite second end of the slot to exit the pin receiver formed in the jaw to free the third and fourth bars to pivot relative to one another to release the foldable four-bar linkage so that the foldable four-bar linkage can be moved to assume the folded shape.

36. A rolling walker comprising
a front assembly including first and second front legs, a front cross bar interconnecting the first and second front legs, first and second pivot mounts coupled to each of the first and second front legs, a front wheel unit coupled to a lower end of each of the first and second front legs, and a push arm coupled to an upper end of each of the first and second front legs,
a rear assembly including first and second rear legs, a rear cross bar interconnecting the first and second rear legs, and a rear wheel unit coupled to a lower end of each of the first and second rear legs, and
a leg-movement control system including a first lower link pivotably coupled to each of the first front leg and the first rear leg, a first bridge link pivotably coupled to each of the first front leg and the first rear leg, and a first lock unit coupled to the first rear leg and to the first bridge link and configured to selectively retain the first bridge link in fixed relation to the first rear leg to establish an unfolded use position of a first side frame unit comprising the first front leg, the first and second pivot mounts coupled to the first front leg, the first rear leg, the first lower link, and the first bridge link, and to release the first bridge link to pivot relative to the rear leg to establish a folded storage position of the first side frame unit.

37. The rolling walker of claim 36, further comprising a seat coupled to the front and rear cross bars and a seat back coupled to the first and second front legs.

38. The rolling walker of claim 37, wherein the leg-movement control system further includes a second lower link pivotably coupled to each of the second front leg and the second rear leg and a second bridge link pivotably coupled to each of the second front leg and second rear leg and wherein the seat is positioned to lie between the first and second bridge links.

39. The rolling walker of claim 48, wherein the leg-movement system further includes a second lock unit coupled to the second rear leg and to the second bridge link and the seat is located between the first and second lock units.

40. The rolling walker of claim 36, wherein the first bridge link is formed to include an interior channel and an exterior wall formed to include an elongated slot opening into the interior channel and the first lock unit includes a pin carrier mounted for back-and-forth sliding movement in the interior channel, a lock pin coupled to the pin carrier to move therewith relative to the first bridge link and arranged to extend through the elongated slot, and a spring arranged to lie in the interior channel and configured to define means for yieldably moving the pin carrier in the interior channel to urge the lock pin to engage one end of the elongated slot.

41. The rolling walker of claim 40, wherein the first lock unit further includes a jaw formed to include a cavity and a side wall formed to include a pin receiver, the bridge link is sized and arranged to lie in the cavity to cause the lock pin to extend into the pin receiver to block pivotable movement of the first rear leg relative to the bridge link.

42. The rolling walker of claim 41, wherein the first lock unit further includes means for moving the pin carrier against a biasing force established by the spring to move the lock pin toward an opposite end of the elongated slot to cause the lock pin toward an exit of the pin receiver so that pivotable movement of the first leg relative to the bridge link is unblocked.

43. The rolling walker of claim 36, wherein the first lower link and the first rear leg cooperate to form therebetween an included angle of about 70° upon establishment of the unfolded use position of the first side frame unit and of about 145° upon establishment of the folded storage position of the first side frame unit.

44. The rolling walker of claim 36, wherein the first rear leg and the first bridge unit cooperate to form therebetween an included angle of about 180° upon establishment of the unfolded use position of the first side frame unit and of about 35° upon establishment of the folded storage position of the first side frame unit.
